(19) United States
(12) Patent Application Publication
(10) Pub. No.: US 2009/0119772 A1
(43) Pub. Date: May 7, 2009

(54) SECURE FILE ACCESS

(76) Inventors: Mariette Awad, South Burlington, VT (US); Adam E. Trojunowski, Chester, VT (US)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/935,601

(22) Filed: Nov. 6, 2007

(51) Int. Cl. G06F 7/04

(52) U.S. Cl. 726/21

(57) ABSTRACT

In one method, the embodiments herein providing secure file access when a user opens an application and uses the application to make a request to open a data file on a secure file system. The method checks a trusted application list, by kernel extension, to determine if the application comprises a trusted application. The method also checks the user's permission to access the secure file system. The embodiments herein pass an “extended” permission to any applications that are trusted applications. Therefore, the methods herein control access to the secure file system based not only on the user's permission, but also on the “extended” permission, such that the kernel extension allows access to files. With embodiments herein, the trusted application performs the extended permission management.

### BACKGROUND AND SUMMARY

The embodiments of the invention generally relate to controlling access to file and data and more particularly to a system and method that utilizes a kernel extension to determine an application's trusted status and to grant extended permissions to trusted applications.

Securing the access to data is difficult to perform with any degree of certainty. Granting only read access to files does not provide total security because the user may still be allowed to copy these file to unsecured locations (external hard drive, printer, etc . . . ). Conventional data access controls are specific to a file format and their proprietary application. Permissions are mostly contained within the file format itself. Those that are not contained within the file format are usually overly broad.

In one method, the embodiments herein providing secure file access when a user opens an application and uses the application to make a request to open a data file on a secure file system. The method checks a trusted application list, by kernel extension, to determine if the application comprises a trusted application. Kernel extensions are loadable kernel modules that are object files that contain code to extend the running kernel, or so-called base kernel, of an operating system.

The method also checks the user's permission to access the secure file system. The embodiments herein pass an “extended” permission to any applications that are trusted applications. The user permission and the “extended” permission are very different. The user permission comprises simple read and write permissions, while the extended permission comprises an allow copy file within secure area permission, an allow copy file outside secure area permission, an allow copy/paste permission, an allow print permission, etc.

Therefore, the methods herein control access to the secure file system based not only on the user's permission, but also on the “extended” permission, such that the kernel extension allows access to files. With embodiments herein, the trusted application performs the extended permission management.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment of the invention; and

FIG. 2 is a schematic diagram illustrating a system embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

Secure access to data and preventing illegal data disposition are not mutually exclusively goals, but they are difficult to simultaneously achieve with a high degree of certainty. Entitled user who have access to data can still illegally disposition of it. Granting read access to file may still allow a user to copy the file to unsecured locations.

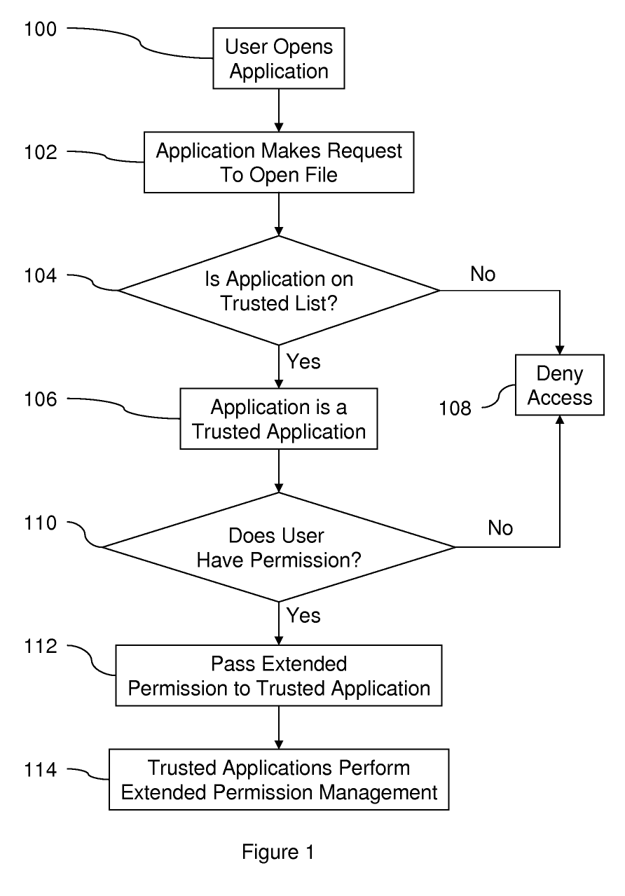

In view of the foregoing, as shown in flowchart form in FIG. 1, the embodiments herein provide secure file access when a user opens an application 100 and uses the application to make a request to open a data file on a secure file system 102. The method checks a trusted application list 104, by kernel extension, to determine if the application comprises a trusted application 106. If the application is not within the trusted application list, access to the secure file system is denied in item 108. The method also checks the user's permission to access the secure file system in item 110 and again denies access to the secure file system (108) if the user does not have permission. The embodiments herein pass an “extended” permission to any applications that are trusted applications in item 112. The user permission and the “extended” permission are very different. The user permission comprises simple read and write permissions, while the extended permission comprises an allow copy file within secure area permission, an allow copy file outside secure area permission, an allow copy/paste permission, an allow print permission, etc.

Therefore, the methods herein control access to the secure file system based not only on the user's permission, but also on the “extended” permission, such that the kernel extension allows access to files. With embodiments herein, the trusted application performs the extended permission management after being granted the extended permissions by the kernel extension as shown in item 114.

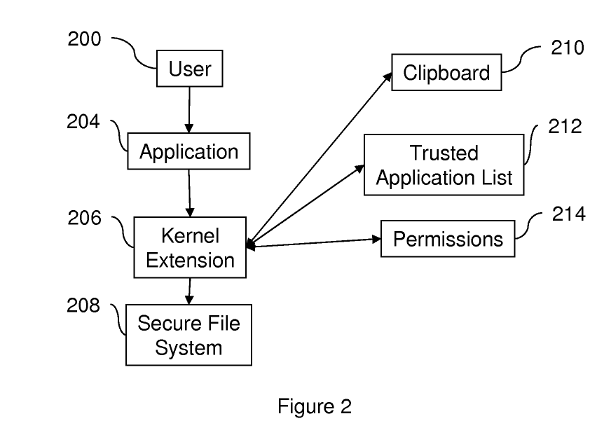

As shown in FIG. 2, this disclosure presents a system for providing secure file access. The system includes a permission storage area 214 (to store permissions for each file/directory), a trusted application list 212, a kernel extension 206 (to check an application's trusted status, allow/block access to secure file system, and pass extended permission from the permission storage area 214 to a trusted application). This system works with the secure file system 208 and the trusted application 204 (which knows how to handle the extended permission).

The permission storage area 214 is used to store permissions for each file/directory. The trusted application list 212 contains applications that are trusted, and such trusted applications have their file checksum or other identifying information stored in the trusted application list 212. The kernel extension 206 of each application is used to check the trusted status of the application so as to allow or block access to the secure file system 208. The secure file system 208 actually stores the files and/or data which needs to be secured. The trusted applications are those understand and abide by the extended permission scheme.

The embodiments herein enhance the standard permission scheme on a secure file system 208 (SFS) to include other extended settings such as “allow copy file within secure area,” “allow copy file outside secure area,” “allow copy/paste,” “allow print,” etc. Thus, embodiments herein, add a “trusted application” list (TAL) 212 to determine which applications are certified to respect these additional extended permissions 214. Embodiments herein allow only “trusted applications” to read files from the secure file system (SFS) 208. The embodiments allow protection of any file type (plain text, design data, etc) and new “trusted applications” can be added at the discretion of the administrator of the data storage area 214 (via the trusted application list 212).

One distinction of embodiments herein is that there are no “locked in” file formats. Therefore, embodiments herein do not require continued purchase of external products. With embodiments herein, there is no change in the file formats used (no “vendor-lock in” which can cause problems if the vendor goes away). Another difference is that the embodiments herein can be extended to provide additional security measures (i.e. more permissions) and that it is easy to add additional “trusted applications”. Also, with embodiments herein, permissions 214 can be managed from a centralized location, and permissions 214 can be kept local to a data storage machine or in a global repository (PSA). Although all applications can execute normally with the embodiments herein, untrusted applications are not permitted to read from the secure file system, hindering data theft.

The following are examples of secure data processing occurring with the example system shown in FIG. 2. With a successful open file process for a trusted application, first the user 200 opens the application 204. The application 204 asks to open a data file on the secure file system 208, the kernel extension 206 sees the attempted access to the secure file system 208 and checks the trusted application list 212. If the application 204 is trusted, the kernel extension 206 checks to see if the user 200 has read permission 214. If the user 200 has read permission 214, the kernel extension 206 gets data from the secure file system 208, and the kernel extension 206 gives data to the application 204.

An example of an open file with an untrusted application begins with the user 200 opening the application 204. The application 204 asks to open the data file on the secure file system 208, the kernel extension 206 sees the attempted access to the secure file system 208 and checks trusted application list 212. Since the application 204 is untrusted, the kernel extension 206 denies the reading from the secure file system 208.

An example of an open file with no user permission begins with the user 200 opening the application 204. The application 204 asks to open the data file on the secure file system 208. The kernel extension 206 sees the attempted access to the secure file system 208 and checks the trusted application list 212. The application 204 is trusted, therefore the kernel extension 206 checks file user permissions 214. However, since the user 200 does not have read permission 214, the kernel extension 206 denies reading from the secure file system 208.

An example of a successful copy text operation occurs when a user 200 asks the application 204 to copy text to a clipboard 210 (the application 204 was already deemed to be trusted when the file was opened). The application 204 asks the kernel extension 206 for permission to allow copying of the text to clipboard 210. The kernel extension 206 checks the permissions 214 and finds that the user 200 has permissions to copy the text. The kernel extension 206 notifies the application 204 that user 200 has permissions to copy text, and the application 204 puts text into clipboard 210.

An example of a copy text operation without user permission occurs as follows. The user 200 asks the application 204 to copy text to the clipboard 210 (the application 204 is already trusted when the file was opened). The application 204 asks the kernel extension 206 for permission to allow copying of the text to clipboard 210. The kernel extension 206 checks permissions 214 and finds that the user 200 has no permission to copy text. Thus, the kernel extension 206 notifies the application 204 that the user 200 does not have permission to copy text, and the application 204 refuses to put text into clipboard 210.

In another example, the trusted application is “/bin/cp”. The standard /bin/cp command should not be trusted as it does not check extended permissions 214 to see if the user 200 has the ability to copy a file within or without the secure file system 208. Therefore, if a user 200 tried to copy any file within the secure file system 208 using /bin/cp, /bin/cp would execute but would fail because it lacks read permissions to the source file (because /bin/cp is untrusted) even though the user 200 might have the read permission. However, a with embodiments herein, a wrapper (application) can be made to first check the extended permissions 214 to see what location the user 200 could copy the requested file, and to what location the user 200 is attempting to copy the requested file. If these permissions 214 were valid, the wrapper then calls /bin/cp to perform the action and then sets the extended permissions 214 on the resulting file (the copy) to match that of the original. In this case, the wrapper is a trusted application. Alternatively, another copy of the application could be re-written with the additional security permissions 214 checking and matching built-ins. This version could be a trusted application by itself. In either case, an administrator certifies that the application is trusted (trusted to follow the extended permissions 214).

Therefore, as shown above, securing the access to data is difficult to perform with any degree of certainty. Conventional data access controls are specific to a file format and their proprietary application. The embodiments herein check a trusted application list, by kernel extension, to determine if the application comprises a trusted application. The method also checks the user's permission to access the secure file system. The embodiments herein pass an “extended” permission to any applications that are trusted applications. Therefore, the methods herein control access to the secure file system based not only on the user's permission, but also on the “extended” permission, such that the kernel extension allows access to files. With embodiments herein, the trusted application performs the extended permission management.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of providing secure file access comprising:
requesting, by an application, to open a data file on a secure file system;
checking a trusted application list to determine if said application comprises a trusted application;
passing an extended permission to any applications that comprise said trusted application; and
controlling access to said secure file system based on said extended permission such that said trusted application performs extended permission management.

2. The method according to claim 1, all the limitations of which are incorporated herein by reference, wherein said user permission comprises read and write permissions.

3. The method according to claim 1, all the limitations of which are incorporated herein by reference, wherein said extended permission comprises:
an allow copy file within secure area permission;
an allow copy file outside secure area permission;
an allow copy/paste permission; and
an allow print permission.

4. A method of providing secure file access comprising:
opening an application by a user;
requesting, by said application, to open a data file on a secure file system;
checking a trusted application list, by kernel extension, to determine if said application comprises a trusted application;
checking a user permission to access said secure file system;
passing an extended permission to any applications that comprise said trusted application; and
controlling access to said secure file system based on said user permission and said extended permission such that said kernel extension allows access to files and said trusted application performs extended permission management.

5. The method according to claim 4, all the limitations of which are incorporated herein by reference, wherein said user permission comprises read and write permissions.

6. The method according to claim 4, all the limitations of which are incorporated herein by reference, wherein said extended permission comprises:
an allow copy file within secure area permission;
an allow copy file outside secure area permission;
an allow copy/paste permission; and
an allow print permission.
